(19) United States
(12) Patent Application Publication
(10) Pub. No.: US 2008/0220238 A1
(43) Pub. Date: Sep. 11, 2008

(54) Environmental protection and safety sign pad and manufacturing method thereof

(76) Inventor: Su-Tuan Hsu Tang, Taoyuan County (TW)

Correspondence Address: HSU TANG, SU-TUAN, P.O. Box 44-2049, Taipei, 10668, TW

(21) Appl. No.: 11/714,184

(22) Filed: Mar. 6, 2007

(51) Int. Cl. B32B 3/26; B05D 3/00

(52) U.S. Cl. 428/304.4; 427/299

(57) ABSTRACT

The present invention discloses an environmental protection and safety pad and a manufacturing method thereof. The manufacturing method includes: providing a continuously outputted central mesh fabric; coating a soft polymer raw material onto the central mesh fabric according to a predetermined pattern by a plurality of material releasing/flow control systems that installs a soft polymer raw material such as a reflective glass bead or a fluorescent color powder of different hues; and finally providing a predetermined high temperature of the central mesh fabric of the coated soft polymer raw material, so that the soft polymer raw materials are foamed to form an environmental protection and safety pad with two or more colors and having reflective, wearing-resisting and biodegradable features.

### BACKGROUND OF THE INVENTION

(1) Field of the Invention

The present invention relates to an environmental protection and safety sign pad and a manufacturing method thereof, and more particularly to an environmental protection and safety sign pad and a manufacturing method applied in a reflective sign and formed by a multicolor pad manufacturing technology, and satisfying the reflective, multicolor, high-elasticity, durable and collision resisting requirements.

(2) Description of the Prior Art

In general, a conventional safety sign board comes with a single-layer structure that attaches or sticks a reflective board (or a reflective sticker) directly onto a bottom board of an iron board, an aluminum board, a metal board or a composite resin board or an object (such as an electric pole, a guard rail and a wall) for reflecting a color light. Due to the limitation of the structure, the reflective board with a thin surface may be damaged easily by external collision or rubbing, and the reflective function at the damaged position may disappear. More particularly, most of the products with a label function of this sort are installed at a hazardous environment, and thus these safety sign boards may be damaged by external forces easily. The inventor of the present invention manufacturing a multi-color elastic pad by using a pad manufacturing technology, and the colors of the multi-color elastic pad is applicable for a label, and the elasticity of the multi-color elastic pad provides a more durable and collision resisting effect.

As to the conventional “monochrome” pad manufacturing technology, a common raw material used is a platicizer made of diisononyl phthalate (DINP), dioctyl phthalate (DOP), di-2-ethylhexyl adipate (DOA) or polyvinyl chloride (PVC), and the pad manufacturing technology adopting a platicizer is well developed, but such technology remains at a monochrome stage, and further breakthroughs are needed for developing a pad with two or more colors. The difficulty of developing a multi-color pad resides on that the process of mixing the main materials polyvinyl chloride (PVC) powder and platicizer to produce a paste, and the process requires a high-temperature foaming for the formation, and the formed pad must have excellent elasticity, even thickness and good appearance.

The development of a multi-color pad still has the following bottlenecks:

1. If two sets of pastes made of the main raw materials such as polyvinyl chloride (PVC) powder, platicizer and color powder are mixed separately, and the paste (of different color systems) are produced simultaneously at a plane machine, then it is necessary to maintain a balance of the physical operating conditions of each paste.

2. The coating process of the monochrome paste is very simple, but the process of coating pastes of two or more colors on the same plane simultaneously must control an even distribution of different color pastes in the same unit of pad, and avoid pastes of different color systems from being mixed with each other or chaotically distributed.

3. For the control of shape and appearance of a foamed object, there are many variables related to the monochrome polyvinyl chloride (PVC) material used in a foaming process, and a change of variables including the control of raw materials, material feeding, temperature, speed, tensile stress, and cooling may cause problems including a rough appearance, an excessive thickness, a non-texture feeling, a deformation, a sticky property, and a poor attachment.

Therefore, the variables for the manufacturing of a polyvinyl chloride (PVC) pad with two or more colors are more complicated than those for a monochrome pad.

Secondly, environmental protections can bring tremendous convenience for industries, but plastics from the petroleum and chemical industries also become popular. As a result, a huge amount of plastic trash becomes a secret worry of environmental pollution. According to the surveys conducted by the U.S. Gallup Organization, the solid trash produced by cities in the United States in 2000 approximately amounts to 216 million tons, and the waste plastics occupies 9.8% of the total weight (or over 30% by volume), and the plastic trash produced by Taiwan is up to 15%, and these plastic trashes definitely jeopardize our ecological environment.

Conventional elastic pad products focus on their performance, solid structure and durability, but have not taken the issues of environmental protection and dumping of the products into consideration, and thus serious problems such as heavy metal contaminations may arise after the wastes are buried into soil, and cancer-causing substance may be produced after the wastes are burned.

Therefore, the main raw material (or plasticizer) used for manufacturing conventional elastic pads usually contains phthalates, and 99% of the total quantity of elastic pads available in the market are plasticizers of this sort that contains poisonous substances, since the phthalates provide soft and bendable properties for the manufacturing process of the plastic products. Although these substances are considered as harmful substances by international organizations, they come with a low price and thus they are still used extensively by the plastic industries all over the world and causing unredeemable environmental pollutions.

In view of the shortcomings of the prior art, the inventor of the present invention based on years of experience in the related industry to conduct extensive researches and experiments, and finally developed the sign pad and the method in accordance with the present invention.

### SUMMARY OF THE INVENTION

Therefore, it is a primary objective of the present invention to provide an environmental protection and safety pad and method thereof, wherein the coating technology of a multi-color polymer material and the structure of a pad provide better elasticity for resisting external wearing and collisions and maintaining the reflective label function of the pad. In other words, the colors of the multi-color pad are suitable to be used as a label, and its good elasticity is suitable for the durable and wearing-resisting effects.

To overcome the foregoing shortcomings, the present invention provides an environmental protection and safety pad that comprises a central mesh fabric and a plurality of color lumps. The central mesh fabric includes an upper surface and a lower surface, and a plurality of color lumps are disposed on at least one of upper and lower surfaces of the central mesh fabric according to a predetermined pattern, and the color lumps are formed by foaming a soft polymer raw material (PER) of different hues, and the soft polymer raw material includes polyester platicizer (dioctyl alcohol ester), polyvinyl chloride (PVC), natural polymer and reflective glass bead (sodium calcium silicate glass) or fluorescent color powder.

The present invention provides a manufacturing method of an environmental protection and safety pad, and the method comprises the steps of:

providing and leveling a central mesh fabric, and outputting the central mesh fabric continuously;

coating the soft polymer raw material on the leveled central mesh fabric according to at least one predetermined pattern through at least one side of the central mesh fabric and a plurality of material releasing/flow control systems having a soft polymer raw material of different hues, and the soft polymer raw material includes a polyester platicizer, a polyvinyl chloride (PVC), a natural polymer and a reflective glass bead or a fluorescent color powder; and

providing a predetermined high temperature to the coated soft polymer raw material of the central mesh fabric, and the predetermined high temperature is provided for foaming and shaping the soft polymer raw material.

### BRIEF DESCRIPTION OF THE DRAWINGS

FIG. 1 is a perspective view of an environmental protection and safety pad in accordance with a first preferred embodiment of the present invention;

FIG. 2 is a schematic view of a manufacturing method of an environmental protection and safety pad in accordance with a first preferred embodiment of the present invention;

FIG. 3 is a schematic view of a manufacturing method of an environmental protection and safety pad in accordance with a second preferred embodiment of the present invention;

FIG. 4 is a schematic view of an environmental protection and safety pad applied in an electric pole in accordance with the present invention;

FIG. 5 is a schematic view of an environmental protection and safety pad applied in a garage in accordance with the present invention; and

FIG. 6 is a schematic view of an environmental protection and safety pad applied in a guard rail in accordance with the present invention.

### DETAILED DESCRIPTION OF THE PREFERRED EMBODIMENTS

To make it easier for our examiner to understand the technical characteristics of the invention, we use preferred embodiments together with the attached drawings for the detailed description of the invention.

The present invention provides an environmental protection and safety pad and method thereof applied in safety signs such as various different reflective signs that require having the environmental protection, high elasticity, reflective light, multi-color, durable and wearing-resisting effects.

The environmental protection and safety pad of the present invention uses a mesh fabric as the material for making its supporting frame, and a soft polymer raw material (also known as PER material or PER) wrapped around the exterior of the pad, and the PER is wrapped by colors and regions, and thus the same unit of a pad can show two or more different color systems directly, and then the pad is added with a reflective glass bead or a fluorescent color powder to provide a light reflecting effect for the environmental protection and safety pad.

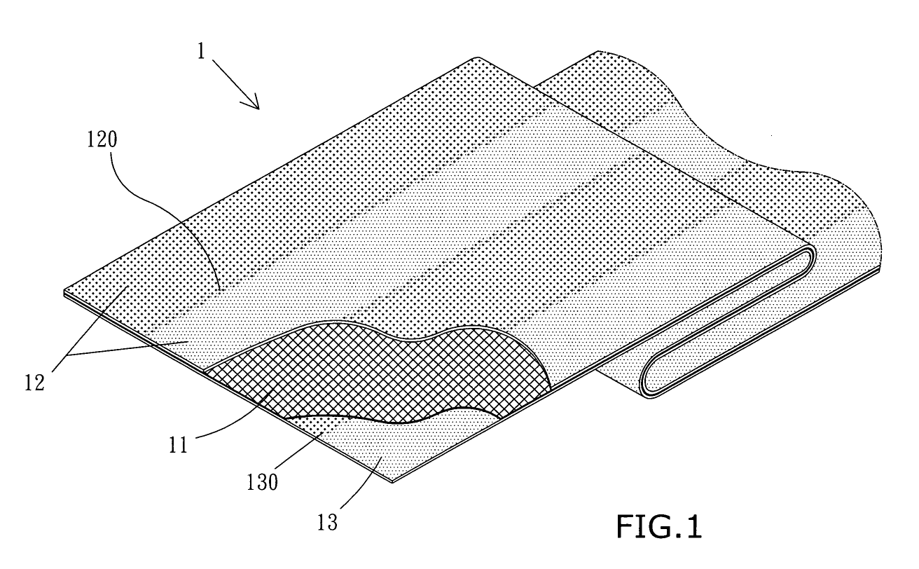

Referring to FIG. 1 for a perspective view of an environmental protection and safety pad in accordance with a first preferred embodiment of the present invention, the pad comprises a central mesh fabric 11 having an upper surface and a lower surface, and a plurality of color lumps 12, 13 are distributed on one of the upper and lower surfaces of the central mesh fabric 11 (or both of the upper and lower surfaces) according to a predetermined pattern as shown in this embodiment. The plurality of color lumps 12, 13 are distributed on both upper and lower surfaces of the central mesh fabric 11, and the plurality of color lumps 12, 13 are distributed on central mesh fabric 11 according to two same or two different predetermined patterns. The plurality of color lumps 12, 13 are made by mixing soft polymer raw materials for the environmental protection and color materials with different hues and a foaming process. The soft polymer raw materials include several compositions as given below: the first composition is comprised of polyester platicizer (dioctyl alcohol ester), polyvinyl chloride (PVC), natural polymer (which is muscilage, cellulose, or starch) and reflective glass bead (sodium calcium silicate glass) or fluorescent color powder; the second composition is comprised of natural polymer (which is muscilage, cellulose, or starch) cross-linked by polyol and isocyanate or acrylic resin, and added with fluorescent color powder to achieve a light reflecting effect or mixed with polyolefin material TPO or TPV (which is a type of thermoplastic elastomers, TPE); such that the soft polymer raw material has the environmental protection function without containing any toxic substance such as azo dyes, cadmium, vinyl chloride monomer (VCM), nonylphenol, or organic tin. Since the soft polymer raw material PER contains natural polymer (such as starch or plant cellulose) therefore the used pads can be buried in soil to serve as a nutrient source for the microorganisms and fungi after its biodegeneration. The pads can be biodegenerated into small pieces and then totally disappeared within a specific time under the natural environment. Thus, the present invention can reduce the impact of the waste plastic pads to the environment. Since the soft polymer raw materials are coated according to the colors and regions, a clear and definite boundary 120, 130 is disposed between the plurality of color lumps 12, 13, and an obvious hue is provided. In addition, the predetermined pattern can be a geometric figure, a general figure or a word. The predetermined pattern of this embodiment contains a plurality of parallel strip lines.

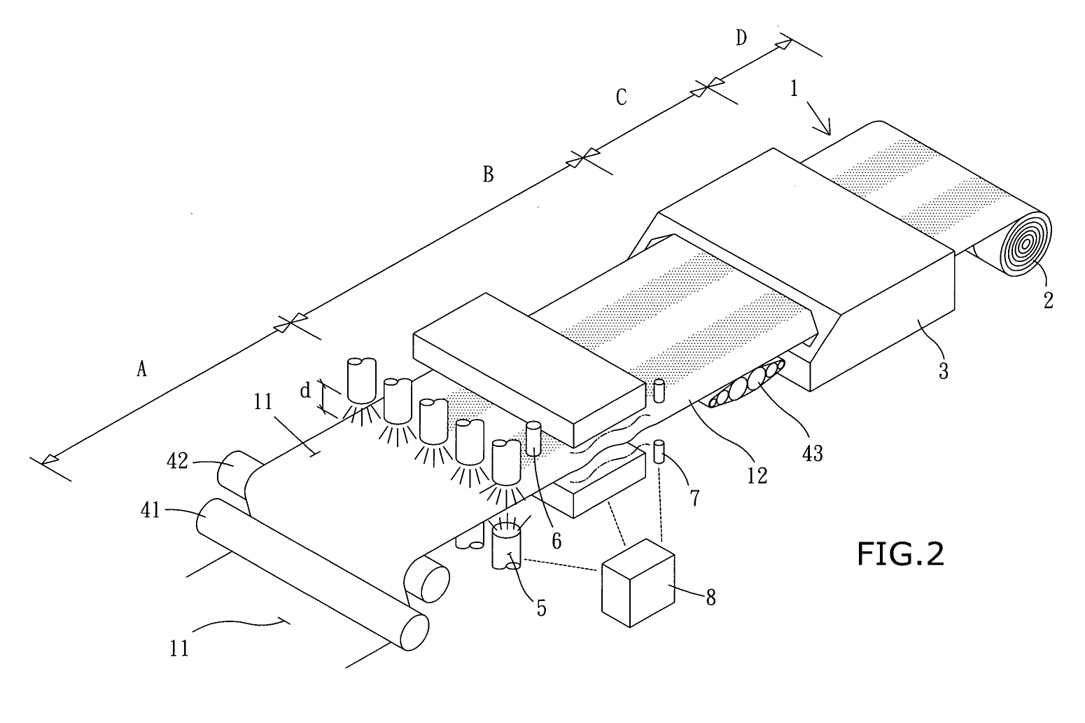

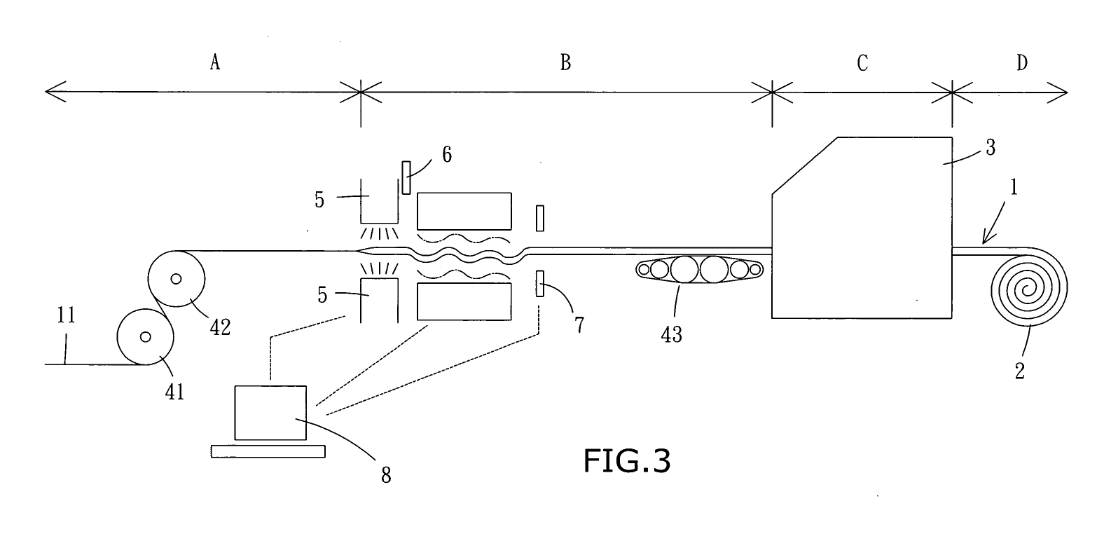

Referring to FIGS. 2 and 3 for schematic views of manufacturing methods of an environmental protection and safety pad 1 in accordance with two preferred embodiments of the present invention respectively, the manufacturing method comprises the steps of: (a) providing at least two rollers 41, 42 installed alternately with each other, a central mesh fabric 11 disposed between the two rollers 41, 42 and pressed tightly with the two rollers 41, 42 for driving the two rollers 41, 42 to Region A and achieving the effect of leveling the central mesh fabric 11, and continuously outputting the central mesh fabric 11; (b) sending the central mesh fabric 11 to Region B, and coating a soft polymer raw material on the leveled central mesh fabric 11 according to at least one predetermined pattern through at least one side of the central mesh fabric 11 and a plurality of material releasing/flow control systems 5 having a soft polymer raw material of different hues, and the soft polymer raw material includes a polyester platicizer, a polyvinyl chloride (PVC), a natural polymer and a reflective glass bead or a fluorescent color powder; the plurality of material releasing/flow control systems 5 comes with at least one predetermined output speed at a predetermined distance d from the central mesh fabric 11 for providing an appropriate raw material output quantity to control an appropriate thickness of foaming the raw materials; installing a digital image monitoring system 6 and a thickness control system 7 sequentially behind the material releasing/flow control system 5; wherein the material releasing/flow control system 5, the digital image monitoring system 6, and the thickness control system 7 are operated by a central electric control system 8, and the digital image monitoring system 6 is provided for monitoring the distribution of the coating material and feeding back the monitored data to the central electric control system 8 to control the thickness control system 7 and provide an even adjustable coating material to uneven semi-finished goods; the central electric control system 8 further adjusts the flow for the material releasing/flow control system 5 according to the unevenly distributed data; wherein the plurality of material releasing/flow control systems 5 are installed on the same side of the central mesh fabric 11 as shown in FIG. 2; or the plurality of material releasing/flow control systems 5 are installed on different sides of the central mesh fabric 11 as shown in FIG. 3; (c), providing a predetermined high temperature the central mesh fabric 11a for of the coated soft polymer raw material when the central mesh fabric 11 is transmitted to Region C, and the predetermined high temperature is provided by an oven 3 for foaming the soft polymer raw material; and providing a conveyor belt 43 (or a roller, and this embodiment adopts the conveyor belt) installed at a front end of the oven 3 for transmitting the central mesh fabric 11 of the coated soft polymer raw material in the midway; (d) entering into Region D after the foaming process is completed to produce an environmental protection and safety pad 1, and curling the foamed environmental protection and safety pad 1 to finally form a tape-like environmental protection and safety pad 2.

In addition, different predetermined patterns can be arranged by the plurality of material releasing/flow control systems 5, or a motor (not shown in the figure) is added for driving the dynamic layout of the predetermined pattern. The plurality of material releasing/flow control systems 5 can include the following implementation modes: (i) The plurality of linearly arranged material releasing/flow control systems 5 are perpendicular to the output direction of the central mesh fabric 11 for creating the predetermined pattern having a plurality of parallel strip lines; or (ii) the plurality of material releasing/flow control systems 5 are installed according to a predetermined proportion for creating the predetermined pattern having a plurality of parallel strip lines according to the predetermined proportion; or (iii) the plurality of material releasing/flow control systems 5 create the predetermined pattern having a plurality of parallel equidistant strip lines according to a predetermined proportion; or (iv) providing a driving motor capable of moving the plurality of material releasing/flow control systems 5 and the driving motor moving the plurality of material releasing/flow control systems 5 to complete the predetermined pattern, and produce the environmental protection and safety pad 1 having the predetermined pattern.

Since the soft polymer raw materials served as the main raw materials of making the environmental protection and safety pad of the invention include a polyester platicizer (or a dioctyl alcohol ester) or a natural polymer, and the manufacturability of the aforementioned two materials are not as good as the platicizer and emulsified powder (or PVC powder), therefore the operation of the quality control system at the middle or later stages becomes very important, in addition to the control of the multi-color control system.

From the description above, the environmental protection and safety pad and its manufacturing method have the following advantages:

The soft polymer raw materials are coated according to colors and regions, and thus the hue of the same unit of the environmental protection is very clear; and the raw material output quantity, output speed and oven temperature can be used for controlling an even thickness of the foamed pad.

The multi-color soft polymer raw materials can be formed either on two surfaces (or a single surface) of a central mesh fabric to improve the flexibility of the product design and obtain a better product competitiveness.

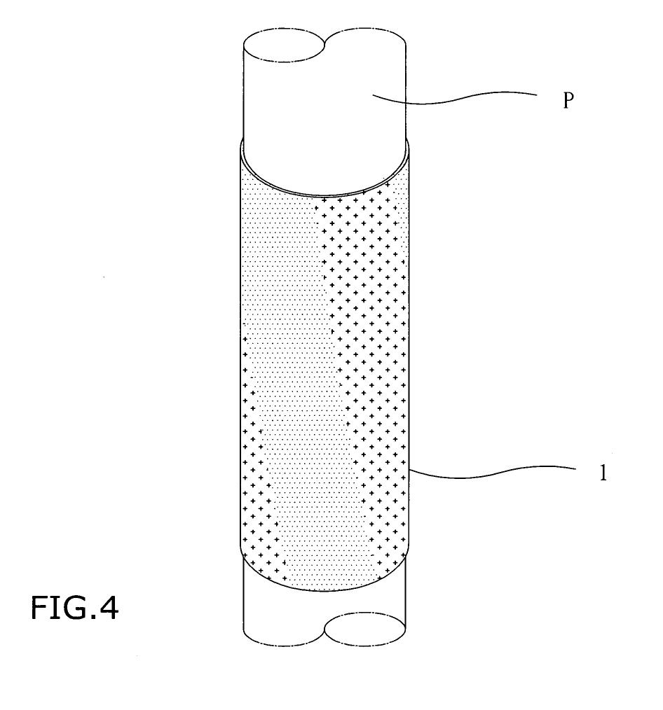

Referring to FIG. 4 for an environmental protection and safety pad 1 wrapped or stuck directly on an electric pole P in accordance with the present invention, the electric pole P set in a hazardous place gives an excellent light reflecting effect, so that people at nighttime can see the electric pole clearly to avoid accidents.

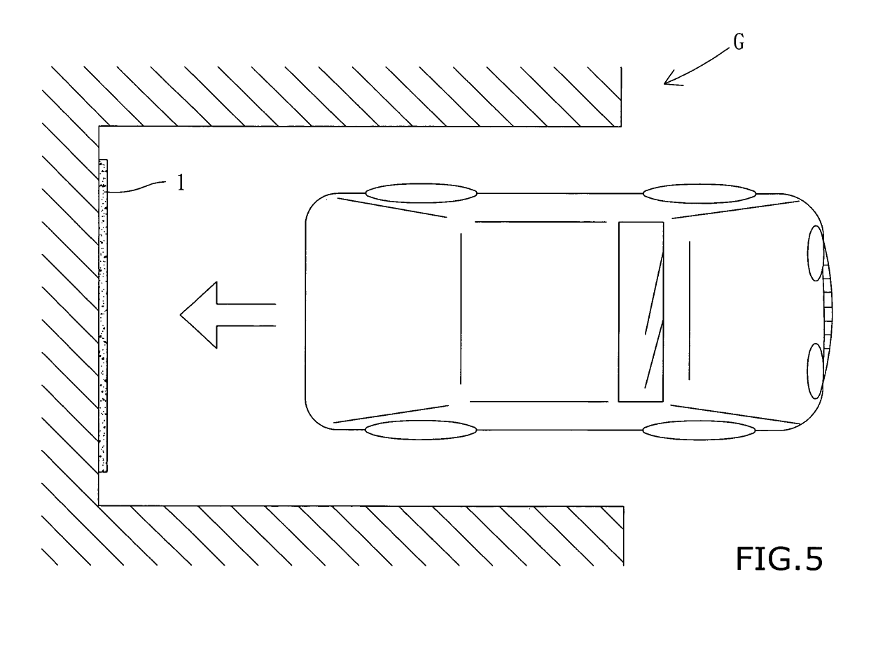

Referring to FIG. 5 for an environmental protection and safety pad 1 applied in a garage G (or installed at the rear wall of the garage G), a user can see the rear wall clearly while reversing a car and avoid hitting the rear wall of the garage G or prevent the environmental protection and safety pad 1 from being damaged even the car hits the wall.

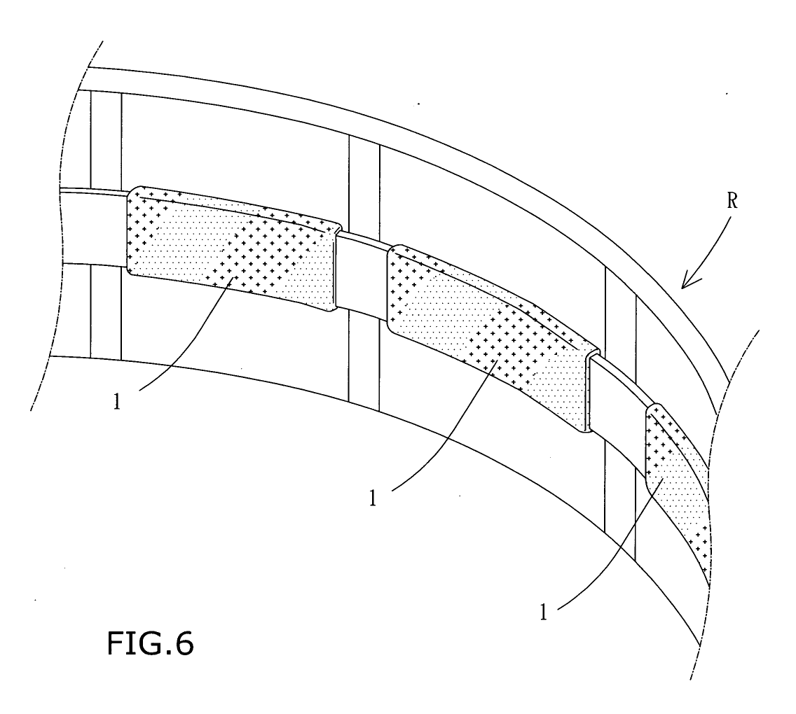

Referring to FIG. 6 for an environmental protection and safety pad 1 applied in guard rail R of a roadside, the environmental protection and safety pad 1 is wrapped or stuck directly onto the guard rail R, so that users can see the guard rail R clearly while making a turn without rubbing or hitting the car, and prevent the environmental protection and safety pad 1 from being damaged.

Since the environmental protection and safety pad of the invention is used as a reflective sign (such as a reflective sign board for roads, a traffic safety reflective sign board used for an electric pole, a safety reflective sign of a car and reflective sign boards used in factories, construction sites, parking lots, and other business locations at nights or in a dark environment, so as to prevent accidents), therefore the pad should come with a light reflective feature or provide a reflection of a color light in the incident direction. The fluorescent soft polymer raw materials are mixed with broken pieces of glass beads in the same color system or the soft polymer raw material formed by reflective glass beads (sodium calcium silicate glass) or fluorescent color powders, and thus the soft polymer raw material provides the environmental protection effect without containing any toxic substance. Since the pad contains natural polymer (such as starch and plant cellulose), the wasted pads can be buried into soil to serve as a nutrient source for microorganisms and fungi after a biodegeneration is performed, and the waste pad can be biodegenerated into small pieces and totally disappeared within a specific time in the natural environment.

With the coating technology of the multi-color polymer materials and the structure of the pad, a better elasticity is provided, so that the pad can bear external wearing and collisions and maintain the reflective label function.

Since the pad comes with high elasticity, durable and good wearing-resisting effects, the pad is suitable to be used as a reflective sign. Furthermore, the products of this sort is usually installed at a hazardous environment, and thus these produce need to have the durable and wearing-resisting functions.

In summation of the above description, the overall assembly and characteristics of the present invention herein enhance the performance than the conventional structure and further complies with the patent application requirements and is duly filed for a patent application.

While the invention has been described by means of specific embodiments, numerous modifications and variations could be made thereto by those skilled in the art without departing from the scope and spirit of the invention set forth in the claims.

What is claimed is:

1. An environmental protection and safety pad, comprising:
a central mesh fabric, having an upper surface and a lower surface; and
a plurality of color lumps, disposed on at least one surface of the lower surface of the central mesh fabric according to a predetermined pattern, and formed by foaming soft polymer raw materials (PER) with different hues, and the soft polymer raw material is a polyester platicizer (dioctyl alcohol ester), polyvinyl chloride (PVC), natural polymer and a reflective glass bead (sodium calcium silicate glass) or a fluorescent color powder.

2. The environmental protection and safety pad as claimed in claim 1, wherein the soft polymer raw material can be substituted by a natural polymer crosslinked with polyol and isocyanate or acrylic resin.

3. The environmental protection and safety pad of claim 1, wherein the soft polymer raw material can be substituted by a natural polymer mixed with a polyolefin material TPO or TPV (which is a thermoplastic elastomer, TPE).

4. The environmental protection and safety pad as claimed in claim 1, wherein the natural polymer is muscilage, cellulose or starch.

5. The environmental protection and safety pad of claim 1, wherein the each color lump has a boundary.

6. The environmental protection and safety pad as claimed in claim 1, wherein the predetermined pattern is a plurality of parallel strip lines.

7. The environmental protection and safety pad as claimed in claim 1, wherein the predetermined pattern is a geometric figure, a general figure or a word.

8. A manufacturing method of an environmental protection and safety pad, comprising the steps of:
providing and leveling a central mesh fabric, and outputting the central mesh fabric continuously;
coating the soft polymer raw material on the leveled central mesh fabric according to at least one predetermined pattern through at least one side of the central mesh fabric and a plurality of material releasing/flow control systems having a soft polymer raw material of different hues, and the soft polymer raw material includes a polyester platicizer, a polyvinyl chloride (PVC), a natural polymer and a reflective glass bead or a fluorescent color powder; and
providing a predetermined high temperature to the coated soft polymer raw material of the central mesh fabric, and the predetermined high temperature is provided for foaming and shaping the soft polymer raw material.

9. The manufacturing method of an environmental protection and safety pad as claimed in claim 8, wherein the step of leveling the central mesh fabric further comprises the steps of:
providing at least two rollers installed alternately with each other; and
installing the central mesh fabric between the two rollers and pressing the two rollers tightly;
such that the central mesh fabric is leveled.

10. The manufacturing method of an environmental protection and safety pad as claimed in claim 8, wherein the step of coating the soft polymer raw material further comprises the step of:
applying a soft polymer raw material of different hues to the plurality of material releasing/flow control systems.

11. The manufacturing method of an environmental protection and safety pad as claimed in claim 8, wherein the step of coating the soft polymer raw material further comprises the step of:
setting a predetermined distance from the central mesh fabric for the plurality of material releasing/flow control systems, and at least one predetermined output speed for providing an appropriate raw material output quantity.

12. The manufacturing method of an environmental protection and safety pad as claimed in claim 8, wherein the step of coating the soft polymer raw material further comprises the step of:
installing the plurality of material releasing/flow control systems on the same side or the different side with the central mesh fabric.

13. The manufacturing method of an environmental protection and safety pad as claimed in claim 8, wherein the step of coating the soft polymer raw material further comprises the step of:
arranging the plurality of linear material releasing/flow control systems perpendicular to the output direction of the central mesh fabric to create the predetermined pattern with a plurality of parallel strip lines.

14. The manufacturing method of an environmental protection and safety pad as claimed in claim 13, wherein the step of coating the soft polymer raw material further comprises the step of:
installing the plurality of material releasing/flow control systems according to the predetermined proportion to create the predetermined pattern with a plurality of parallel strip lines according to the predetermined proportion.

15. The manufacturing method of an environmental protection and safety pad as claimed in claim 14, wherein the step of coating the soft polymer raw material further comprises the step of:
installing the plurality of material releasing/flow control systems in equal proportions;
so as to create the predetermined pattern with a plurality of parallel equidistant strip lines.

16. The manufacturing method of an environmental protection and safety pad as claimed in claim 8, wherein the step of coating the soft polymer raw material further comprises:
providing a driving motor capable of moving the plurality of material releasing/flow control systems; and
moving the plurality of material releasing/flow control systems by the driving motor according to the predetermined pattern; so as to produce an environmental protection and safety pad with the predetermined pattern.

17. The manufacturing method of an environmental protection and safety pad as claimed in claim 8, wherein the step of coating the soft polymer raw material further comprises the step of:
installing a thickness control system behind the material releasing/flow control system.

18. The manufacturing method of an environmental protection and safety pad as claimed in claim 17, wherein the step of coating the soft polymer raw material further comprises the step of:
applying an adjustable uniform wind-flowing coating material to the thickness control system.

19. The manufacturing method of an environmental protection and safety pad as claimed in claim 18, wherein the step of coating the soft polymer raw material further comprises:
installing a digital image monitoring system between the material releasing/flow control system and the thickness control system for monitoring the distribution of coated materials.

20. The manufacturing method of an environmental protection and safety pad as claimed in claim 8, wherein the step of coating the soft polymer raw material further comprises:
providing at least one conveyor belt or a roller installed behind the thickness control system.

21. The manufacturing method of an environmental protection and safety pad as claimed in claim 8, wherein the step of foaming the soft polymer raw material further comprises:
curling the foamed environmental protection and safety pad; and
forming a tape-like environmental protection and safety pad.
